(19) United States
(12) Patent Application Publication
(10) Pub. No.: US 2018/0354702 A1
(43) Pub. Date: Dec. 13, 2018

(54) OXYGEN SCAVENGING FILMS, PACKAGES, AND RELATED METHODS

(71) Applicant: Bemis Company, Inc., Neenah, WI (US)

(72) Inventors: Yuan Liu, Neenah, WI (US); Jerome E. McGinnis, Sherwood, WI (US)

(21) Appl. No.: 15/781,967

(22) PCT Filed: Dec. 6, 2016
(86) PCT No.: PCT/US2016/065127

§ 371 Date: Jun. 6, 2018

Related U.S. Application Data
(60) Provisional application No. 62/264,105, filed on Dec. 7, 2015.

(51) Int. Cl. B65D 81/26; B65D 75/26; B65D 75/36; B32B 7/12; B32B 15/085; B32B 15/20; B32B 27/32; B32B 27/30; B32B 27/28

(52) U.S. Cl. CPC B65D 81/267; B32B 2439/80; B65D 75/36; B32B 7/12; B32B 15/085; B32B 15/20; B32B 27/322; B32B 27/325; B32B 27/306; B32B 27/28; B32B 2250/05; B32B 2307/7244; B32B 2307/7265; B32B 2439/40; B65D 75/26

(57) ABSTRACT

Disclosed herein films and packages formed therefrom for packaging oxygen-sensitive products. The films include a product contact layer comprising COC and catalyst. Introduction of a gas flush including hydrogen gas to a package made from said films helps provide for the catalytic combination of molecular hydrogen and molecular oxygen to remove oxygen from a headspace of the package.

### BACKGROUND

The present disclosure relates generally to the field of films for use in packaging applications. More specifically, the present disclosure relates to films and packages formed therefrom for packaging oxygen-sensitive products such as oxygen-sensitive pharmaceutical products.

### SUMMARY

One embodiment relates to a package for an oxygen-sensitive pharmaceutical product providing for oxygen scavenging without the presence of a hydrogen generator. The package comprises at least one pharmaceutical product storage space and a first multilayer film. The first multilayer film comprises a product contact layer comprising COC and a hydrogenation-accelerating catalyst and a gas harrier layer exterior to the product contact layer.

Another embodiment relates to an oxygen scavenging film for packaging an oxygen-sensitive product, the product comprising a pharmaceutical active agent. The film comprises a gas barrier layer and a product contact layer. The product contact layer comprises COC and a palladium catalyst.

Another embodiment relates to a method of making an oxygen scavenging film. The method comprises providing a COC, providing a palladium catalyst, compounding the COC and the palladium catalyst; and creating a product contact layer comprising the COC and palladium catalyst.

Another embodiment, relates to a method for achieving a sufficiently, oxygen-free product storage space in a package. The method comprises utilizing a multilayer packaging film and introducing a teas flush into the product storage space, the gas flush including hydrogen gas and an inert gas. The multilayer film comprises a product contact layer comprising COC and a catalyst as well as a gas barrier layer disposed exterior the product contact layer. The multilayer packaging film at least in part defines a product storage space.

### BRIEF DESCRIPTION OF THE DRAWINGS

FIG. 1 is a schematic cross-sectional view of a multilayer film according to an exemplary embodiment,

FIG. 2 is a schematic cross-sectional view of a multilayer film according to another exemplary embodiment.

FIG. 3 is a schematic cross-sectional view of a multilayer film according to another exemplary embodiment.

FIG. 4 is a schematic cross-sectional view of a multilayer film according to another exemplary embodiment.

FIG. 5 is a top plan view of a flat format, package for a thin format pharmaceutical product according to an exemplary embodiment.

FIG. 5A is a cross-sectional view of the package of FIG. 5 taken along line A-A according to an exemplary embodiment.

FIG. 6 is a top perspective view of a package that is a blister package according to an exemplary embodiment.

FIG. 6A is a cross-sectional view of the package of FIG. 6 taken along line A-A according to an exemplary embodiment.

FIG. 7A is a perspective view of a partially formed flat format package for a thin format pharmaceutical product according to an exemplary embodiment.

FIG. 7B is a perspective view of the flat format package for a thin format pharmaceutical product of FIG. 7A shown closed according to an exemplary embodiment.

FIG. 8 is a plan view of a pouch according to an exemplary embodiment.

FIG. 9 is a plan view of a pouch according to an exemplary embodiment.

FIG. 10 is a perspective view of a bag according to an exemplary embodiment.

### DETAILED DESCRIPTION

The pharmaceutical industry has a particularly high demand for packaging solutions which demonstrate moisture, dust, UV and/or gas barriers, because these properties are often desired for maintaining the integrity of the product therein.

In many current packaging configurations, significant amounts of oxygen are retained within the package (i.e., in the headspaee or volume adjacent the product contained within the package) after sealing (or otherwise enclosing) the product in the product storage space. For oxygen-sensitive products, including, in particular, pharmaceutical products, the presence of oxygen in the package can result in oxidation that detrimentally impacts the product, for example, the efficacy of the product and/or shelf life of the product. Accordingly, it is generally desirable to package oxygen-sensitive products in a way that minimizes exposure to oxygen.

It has been found that minimizing exposure of a pharmaceutical product to oxygen is particularly desirable in many transdermal patch and oral strip applications (hereafter referred to at times as thin format pharmaceutical products). These pharmaceutical applications often contain pharmaceutical active agents that are sensitive to oxygen exposure (e.g., alkaloids, ethinyl estradiol, estradiol, etc.). For example, the Applicant has found that the integrity of transdermal patches involving nicotine (an alkaloid) can be compromised by presence of oxygen in a package as well as by the packaging itself because of the migration of chemicals.

Relatedly, minimizing exposure of a pharmaceutical product to oxygen is also particularly desirable for other types of pharmaceutical products including oxygen-sensitive pharmaceutical active agents. For example, the Applicant has found that the rapidly-evolving electronic cigarette (“e-cigarette”) market would particularly benefit from the disclosed innovations, not only because e-cigarettes utilize a pharmaceutical active agent (nicotine), but also because sales environments for e-cigarettes generally require (or at least benefit from) relatively long shelf (e.g., drug stores, convenience stores). Moreover, some nicotine-containing products may yellow with exposure to oxygen, making them less desirable to consumers.

Other examples of oxygen-sensitive pharmaceutical active agents include, but are not limited to, femanyl, nicotine, lidocaine, estradiol, clonidine, ethinyl estradiol, oxybutynin, buprenorphine, granisitron, methylphenidate, and scopolamine. It should be understood that, for the purposes of this application, the word pharmaceutical product as used herein will include any product including a compound for use as a medicinal drug or non-medicinal drug (e.g., tobacco products and other products including nicotine, etc.).

One way to minimize oxygen exposure within a package is to use an oxygen scavenger.

Early references disclose use of oxygen scavengers “sandwiched” or otherwise disposed between layers of a film. For example, U.S. Pat. No. 3,255,0.20 discloses catalysts (Nobel metal of the group consisting of palladium and platinum sandwiched between two different layers of a film (e.g, PE and foil), with one of those layers being a gas permeable membrane. Oxygen is removed by a catalytic combination with hydrogen. These references generally teach against the use of a catalyst having a small particle size (e.g., due to difficulty positioning the particles between the walls of a multi-wall bag).

Some food-packaging-focused references teach the use of oxidizable polymers that participate in the oxygen level reductions. Free radical oxidation is the principle mechanism employed, which is complex and highly chemically reactive. The packaging films of these references most of integrate an oxidizable polymer that uses UV or other radiation to initiate the oxidation reaction, after the package is dosed. While included in the film, the oxidizable polymers are generally separated/distanced from products (e.g., not included in a product contact layer) because the reaction involving the oxidizable polymer creates undesirable byproducts (e.g., odor, chemical species, etc.) and these byproducts may negatively affect sealing of the package as well as the quality of the product within the package. Some references overcome these negative effects by including byproduct absorbers, which are themselves undesirable for other reasons. Moreover, oxidizable polymers are themselves consumed during the absorption reaction; this is in contrast to catalysts, which consume oxygen without themselves being consumed.

Still other references utilize Nobel metal catalysts in combination with water-activated hydrogen generators. While water-activated hydrogen generators may be suitable for the beverage containers for which they are commonly utilized, these generators are not desirable for packaging moisture-sensitive products. For example, U.S. Pat. No. 8,906,299 titled “Scavenging oxygen” highlights the central role of the water-activated hydrogen generators in this art. This reference describes a container that includes a shell made from a polymer (e.g., PET) and incorporating a catalyst (e.g., a palladium catalyst). A closure for the bottle incorporates a plug. The plug includes a hydrogen source (e.g., a hydride). In use, the headspace of the closed beverage container contains a significant amount of water vapor. When this water vapor contacts the hydride of the plug, the hydride produces molecular hydrogen that migrates into the polymer matrix of shell and then combines with oxygen (e.g., already enclosed in the bottle or which may have entered the container through its permeable walls). A reaction between the hydrogen and oxygen takes place, catalyzed by the catalyst, and water is produced. Thus, oxygen is scavenged and the contents of the container are protected from oxidation. For such systems, inclusion of the hydrogen generator in the oxygen scavenging system is beneficial because, over time, hydrogen is continuously produced allowing the consumption of the continuously ingressing oxygen. Moreover, a low water vapor level within the package is not required (or even necessarily desirable) for such applications as it is for many pharmaceutical applications.

Provided herein are oxygen scavenging films for packaging an oxygen-sensitive pharmaceutical product containing a pharmaceutical active agent. Also provided herein are packages formed from said film, methods of making said packages and said film, and methods for achieving an oxygen-free or sufficiently oxygen-free headspace of the packages formed from said film.

Referring generally to the FIGURES, the oxygen scavenging films 100, 200, 300, 400 include an catalyst that is a hydrogenation-accelerating catalyst, desirably a palladium or platinum catalyst that promotes the reaction of molecular oxygen and molecular hydrogen, even more desirably a nanoparticle catalyst. When considering cost, a palladium catalyst is generally preferred to platinum catalyst. As will be discussed in more detail below, oxygen scavenging takes place without the use of a hydrogen generator, is not activated by UV or other radiation, and is incorporated directly into a polymer layer.

Generally, the catalyst is included in a product contact layer a material layer that is intended to be in contact with a contained product and/or that is adjacent to or in facing relationship with such a product without any intervening material layers, as when there is a gap or space between the contained product and the product contact layer). According to exemplary embodiments disclosed herein, the product contact layer comprises a cyclic olefin copolymer (COC), such as an ethylene norbornene copolymer. In general, COCs exhibit a high glass transition temperature (greater than 50° C.), optical clarity, low heat shrinkage, low moisture absorption and low birefringence. These materials have been produced by a number of polymerization techniques Which include chain polymerization of cyclic monomers such as 8,9,10-trinorborn-2-ene (norbornene) of 1,2,3,4,4a,5,8,8a-octa-bydro-, 4:5,8-dimetharionaphthalene (tetracyclododecene) with ethane, or ring-opening metathesis of various cyclic monomers followed by hydrogenation.

In some exemplary embodiments, the product contact layer comprises at least 90 wt. % COC.

In some exemplary embodiments, the product contact layer comprises at least 95 wt. % COC.

In some exemplary embodiments, the product contact layer comprises at least 100 wt. % COC.

In some exemplary embodiments, the product contact layer comprises at least 50 wt. % COC.

In some exemplary embodiments, the product contact layer comprises at least 75 wt. % COC.

The COC in the product contact layer may be blended with compatible polymers such as polyolefins (e.g. polyethylene, LLDPE, EAO copolymers, LDPE), colorants, processing aids and the like.

The Applicant was initially concerned that introduction of a catalyst might disrupt the COC matrix and even create gaps in the polymeric structure, thereby negatively impacting the anti-scalping properties (i.e., resistance migration of chemicals, such as pharmacological active agents or excipients, from the product to the film/layer) of the oxygen scavenging films of this disclosure. Anti-scalping performance is an important consideration for a number of the pharmaceutical products (e.g., nicotine patches or fentanyl patches, lidocaine patches, e-cigarette cartridges, intermediate and bulk transport of the same, iodine, alcohol wipes, etc.) that benefit from the films disclosed herein. In earlier work, Applicant found that use of polymers and components in a blend with the COC may undesirably affect the anti-scalping performance of COC, particularly in a product contact layer, (i.e., resistance to migration of chemicals, such as pharmacological active agents or excipients, between the product and the film/layer).

Applicant was happily surprised when testing indicated that a catalyst did not negatively impact the anti-scalping properties at the oxygen scavenging films of this disclosure. In fact, Applicant unexpectedly observed the opposite of its expected result in nicotine uptake tests, which indicated an improvement in anti-scalping performance (rather than the expected compromised performance) with the addition of a palladium catalyst.

In one test, a control film (100% Topase® COC 8007-600) and an oxygen-scavenging (Topas® COC 8007-600 with 100 ppm palladium catalyst, Hycat 280-10119-1 from ColorMatrix) were cut into 1 inch×quarter inch strips and hung from wires in a glass jar containing undiluted liquid nicotine, but not in direct contact with the liquid nicotine. Both sides of the strips were exposed to nicotine vapor. The nicotine uptake of one set of strips was measured at 2 weeks, the other set of strips at 4 weeks, by immediately (upon removal from its respective jar) dissolving each strip in 1.5 ml isopropanol overnight to help ensure extraction. Gas chromatoaraphy was used to analyze the resultant solutions. Table 1 shows the results of the strips analyzed at 2 weeks reporting the area beneath the characteristic peak of nicotine, an indication of the quantity of nicotine present. Table 2 shows the results of the strips analyzed at 4 weeks.

TABLE 1
Nicotine Uptake at 2 weeks

| | | OXYGEN-SCAVENGING FILM |
|---|---|---|
| | CONTROL FILM | (Topas COC 8007-600 with |
| | (100% Topas COC | 100 ppm palladium catalyst, Hycat |
| | 8007-600) | 280-10119-1 from ColorMatrix) |
| SAMPLE 1 | 48.1 | 44.3 |
| SAMPLE 2 | 53.0 | 43.5 |
| SAMPLE 3 | 49.4 | 43.4 |
| AVERAGE | 50.2 | 43.7 |

TABLE 2
Nicotine Uptake at 4 weeks

| | | OXYGEN-SCAVENGING FILM |
|---|---|---|
| | CONTROL FILM | (Topas COC 8007-600 with |
| | (100% Topas COC | 100 ppm palladium catalyst, Hycat |
| | 8007-600) | 280-10119-1 from ColorMatrix) |
| SAMPLE 1 | 51.7 | 48.3 |
| SAMPLE 2 | 61.8 | 44.1 |
| SAMPLE 3 | 54.8 | 54.0 |
| AVERAGE | 56.1 | 48.8 |

Notably, achieving the benefits of embodiments of the oxygen scavenging films and packages disclosed herein involves utilizing a gas flush of the product storage space that includes hydrogen gas rather than utilizing a hydrogen generator. Use of hydrogen generators can be particularly disadvantageous for pharmaceutical applications because hydrogen generators require moisture-activation. As noted above, moisture can detrimentally affect the integrity of many pharmaceutical products; thus, it is desirable to minimize moisture in a package, particularly avoiding a need to include it for the system to function.

The oxygen scavenging films of the present disclosure further include a gas barrier layer. The gas barrier layer is configured to present the ingress of oxygen to a sealed package and the egress of by from a sealed package. As will be discussed in more detail below, prevention of the egress of hydrogen is particularly desirable because hydrogen retention can facilitate the continuation of the catalyzed reactions between molecular hydrogen and oxygen well after the package has been closed (by heat seal, cold seal, or other suitable method known to those of skill in the art). To effectively reduce the oxygen level inside the package to zero or other sufficiently low percent by weight, the hydrogen level needs to remain high enough so as not to become the limiting factor in the catalyzed reaction.

In this way, a product storage space or headspace that is sufficiently oxygen-free (sufficiently oxygen-free being dependent on the application) for many oxygen-sensitive products can be achieved. What's more, an oxygen-free headspace can be achieved, where an oxygen-free headspace for the purposes of the discussion of oxygen-sensitive pharmaceutical products in this application is a headspace that achieves 0.0% oxygen gas by volume, Applicants have achieved a headspace measuring less than 0.0% oxygen as measured by an Agilent 7890A Gas Chromatograph with a 5975C MSD detector in selective ion mode. In one such case, the oxygen in the headspace was measured to be 75 ppm, or 0.0075% oxygen by volume. Before oxygen measurements were taken, the machine was calibrated using a two point (2.1 and 21%) oxygen calibration curve. A gas tight syringe was used to remove 1 ml of headspace from a test pouch. This headspace was injected into the GC, and the resulting area of the oxygen peak was recorded. The oxygen content of the headspace was then determined to be 75 ppm utilizing this peak and the oxygen calibration curve.

More generally, sufficiently oxygen-free may be considered in terms of percent of oxygen gas by volume or by other relevant metrics. For example, sufficiently oxygen-free may be examined by the percent change in the oxygen percent by volume between two relevant periods of time, such as a point (1) promptly following dosing the package and a point (2) X number of days later (e.g., X=1,2, 5, 10, 365, etc.). The desirable metric may depend on the application. For instance, the same type of package may be run through two different gas flush processes, one resulting in a starting oxygen gas percent by volume of 2% and the other 1%; in such a case, the same percent volume reduction in the oxygen gas content between the same start and end points may be sufficient for one and insufficient for the other (e.g., an 90% reduction in oxygen between closing and day 10 might leave 0.2% oxygen gas by volume in one headspace and 0.1% in the other; if a sufficiently oxygen-free headspace for the application is 0.15% oxygen gas by volume, then one package is sufficiently oxygen-free where the other is not).

### Oxygen Scavenging Film

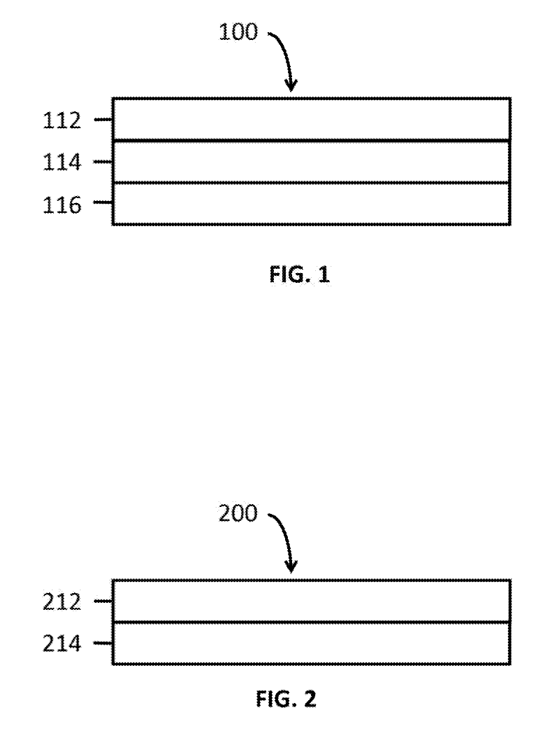

Referring to FIG. 1, an oxygen scavenging film 100 is shown including a product contact layer 112, gas barrier layer 114, and an exterior layer 116 according to an exemplary embodiment.

According to an exemplary embodiment, layers 112, 114 and 116 are be combined by coextrusion methods (e.g., blown film coextrusion).

According to other exemplary embodiments, adhesive layers may be disposed between layers 112 and 114 and layers 114 and 116, but are not shown for simplicity and clarity. Any adhesive layer suitable for promoting adhesion between the respective layers may be used, as would be understood by one of skill in the art.

According to still other exemplary embodiments, a combination of adhesive lamination and coextrusion may be used to combine the layers of the oxygen scavenging film 100.

It is thither contemplated that other layers may be disposed between layers 112 and 114 and layers 114 and 116 (e.g., to serve functional purposes, such as a primer layer).

Referring further to FIG. 1, the product contact layer 112 comprises COC and one or more hydrogenation-accelerating catalysts that catalyze the scavenging of oxygen (e.g., a palladium catalyst, a platinum catalyst, a combination of such catalysts, etc.). As will be discussed in more detail below, COC provides particularly good anti-scalping benefits that are particularly beneficial for packaging of pharmaceutical products that have pharmaceutical active agents.

It is contemplated that the product contact layer 112 may comprise a blend of COC and another thermoplastic material such as, but not limited to homopolymers and copolymers of polyethylene, it is also contemplated that COC may be the only thermoplastic material in the product contact layer 112.

According to an exemplary embodiment, the product contact layer 112 comprises at least 90 wt. % of a COC. According to some of the exemplary embodiments wherein the product contact layer 112 comprises at least 90 wt. % of an ethylene nothomene copolymer, the ethylene norbomene copolymer has a glass transition temperature in a range from 50° C. to 138° C.; as discussed in more detail in International Application No. PCT 20151015246 entitled “Anti-Scalping Pharmaceutical Packaging Film”, which is incorporated herein by reference, these exemplary embodiments provide particularly beneficial resistance to migration of chemicals, such as pharmacological active agents or excipients, between the product and the film.

According to another exemplary embodiment, the product contact layer comprises at least 75 wt. % of an ethylene norbomene copolymer. the remaining 25 wt. % ma include another thermoplastic material such as, but not limited to homopolymers and copolymers of polyethylene.

According to still other exemplary embodiments, the product contact layer may comprise less than 75 wt. % COC. Depending on the anti-scalping needs for the application, the remaining wt. % may beneficially include among other things, other thermoplastic materials with relatively good anti-scalping properties.

According to an exemplary embodiment, forming the product contact layer includes providing a COC, providing a palladium catalyst, and compounding the catalyst (e.g., in the form of a palladium nanoparticle solution) with the COC. One example of a commercially available COC resin for use in the present invention is Topas 8007-600 from Topas Advanced Polymers, although other types of COC resins may be used according to other exemplary embodiments. Exemplary of a commercially available palladium nanoparticle solution is Elyeat 280-10119-1 from ColorMatrix Group. Standard compounding processes can be used to introduce the palladium nanoparticle solution into a polymer melt, as would be understood by those off, skill in the art. Alternatively, known, albeit less common, methods of incorporating the catalyst into the polymer may include performing this operation during polymerization. It should be noted that the catalyst need not be a nanoparticle catalyst. Rather, suitable catalyst sizes include the range wherein the catalyst does not detrimentally disrupt anti-scalping performance (given the application) or other key product layer performance characteristics.

The catalyst is desirably present in the product contact layer 112 at a level high enough to achieve desirable oxygen scavenging, but not so high as to undesirably affect other performance considerations (e.g., anti scalping performance, tackiness, color, etc.) for the product contact layer.

According to an exemplary embodiment in a product contact layer utilizing Topas 8007-600 and Hycat 280-10119-1, the palladium catalyst is desirably present in the product contact layer within the range of 25 ppm to 200 ppm. Generally, the lower limit of the range reflects the amount of the catalyst included to achieve the desired oxygen reduction. The upper limit generally reflects the amount at which the addition of additional palladium catalyst particles undesirably impacts the performance of the compound to be formed into the product contact layer. Above 200 ppm, it was found that the Topas 8007-600 and Hycat 280-10119-1 compound used to form the product contact layer became undesirably tacky.

According to other exemplary embodiments, a palladium catalyst is desirably present in a product contact layer within the range of 20 ppm to 400 ppm.

According to an exemplary embodiment, the product contact layer comprises a palladium catalyst at: 100 PPM.

According to an exemplary embodiment, the product contact layer comprises a palladium catalyst at 75 PPM.

According to an exemplary embodiment, the product contact layer comprises a palladium catalyst at 125 PPM.

According to still other exemplary embodiments, the desirable range of the palladium catalyst (in ppm) may vary depending on the COC type/blend, catalyst format and/or catalyst type.

According to still other exemplary embodiments, it is contemplated that additives may be included in the product contact layer (e.g., processing additives).

Referring further to FIG. 1, the gas barrier layer 114 is disposed exterior to the product contact layer 112 (i.e., relative to the product storage space). As noted earlier, the gas barrier layer helps prevent ingress of oxygen and egress of hydrogen (and other gasses) to a closed package (e g., sealed, heat sealed, cold sealed, etc.). Practically, this means that, in combination with product contact layer 112, gas barrier layer 114 helps retain hydrogen and facilitates achieving an oxygen-free headspace of a package made from the film 100 (or at least a sufficiently oxygen-free headspace, depending on the application). According to the exemplary embodiment shown, the gas barrier layer 114 includes a metallic foil. According to other exemplary embodiments, the gas barrier layer may comprise any metallic foil such as, but not limited to aluminum, tin, copper, blends thereof and the like; these materials are well known in the art. According to still other exemplary embodiment, the gas barrier layer comprises a metallized polymer layer. Any conventional metallization technique known to those skilled in the art can be used to form a metallized polymer layer. One exemplary metallization technique is vacuum deposition wherein the metal is vacuum evaporated and then deposited onto the polymer layer. (See, William Goldie in Metallic Coating of Plastics, Vol. 1, Electrochemical Publications Limited, Chap. 12 ((1968).) A metal may be deposited onto a polymer layer by vapor deposition techniques, typically by applying the molten metal under vacuum by such techniques as electron beam evaporation, sputtering, induction heating, or thermal evaporation. A particularly specific technique for metallization is by electron beam vacuum evaporation deposition methods. According to some embodiments of a metalized polymer layer, the average thickness of the metal is within the range of about 1.0 to 100 nanometers. According to other exemplary embodiments of a metalized polymer layer, the average thickness of the metal is within the range of about 3 to 25 nanometers. (1 micron equals 10⁻⁷ meters, and 1 nanometer equals 10⁻⁸ meters.) Regardless, it is generally desirable that the metal coating has a thickness less than the polymer substrate on which it is deposited, preferably substantially less than said substrate.

Referring further to FIG. 1, the exterior layer 116 is the exterior or outermost layer of the film 100 according to an exemplary embodiment. The exterior layer 116 is configured to prevent damage to a product in a package formed from a film 100 due to handling and other external influences. In addition, the exterior layer 116 is configured to prevent damage to the product contact layer 112 and the gas barrier layer 114. According to the exemplary embodiment shown in FIG. 1 the exterior layer 116 is a biaxially oriented polyester terephthalate (OPET).

According to other exemplary embodiments, the exterior layer may include, but is not limited to, aromatic polyesters such as, but not limited to, polyethylene terephthalate (PET), oriented polyethylene terephthalate (OPET), amorphous polyethylene terephthalate (APET), glycol-modified polyethylene terephthalate (PETG), aliphatic polyesters such as, but not hunted to, polylactic acid (PLA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); or polyamides such as, but not limited to, oriented and unoriented nylon 6, nylon 66, nylon 6/66 and blends thereof, polystyrenes such as, but not limited to, high impact polystyrene (HIPS), general purpose polystyrene (GPPS), and styrene block copolymer (SBC). HIPS is sometimes called rubber-modified polystyrene and is normally produced by copolymerization of styrene and a synthetic rubber. (See Wagner, et al., “Polystyrene,” The Wiley Encyclopedia of Packaging Technology, Second Edition, 1997, pp. 768-771 (John Wiley Sons, Inc., New York, N.Y.).) Examples of HIPS include but are not limited to Impact Polystyrene 825E and Impact Polystyrene 945E, both of which are available from Total Petrochemicals USA, Inc.; EB6025 Rubber Modified High Impact Polystyrene, which is available from Chevron Phillips Company (The Woodlands, Tex.); and 6210 High Impact Polystyrene, which was at one time available from Ineos Nova LLC (Channahon, Ill.). Alternatively, the thermoplastic filial may comprise a polyolefin such as polyethylene including, but not limited to, high density polyethylene (HDPE), medium density polyethylene (MDPE), low density polyethylene (LOPE), linear low density polyethylene (LLDPE), very low density polyethylene (VLDPE), ultra-low density polyethylene (ULDPE) and blends thereof, or polypropylene and blends thereof. A non-limiting example of high density polyethylene includes Alathon® M6020 from Equistar Chemicals LP (Houston, Tex.). Other specific non-limiting examples of HDPE include Alathon® M6020 available from Equistar Chemicals LP (Houston, Tex.); Alathon® L5885 available from Equistar Chemicals LP (Houston, Tex.); ExxonMobil™ HDPE HD 7925.30 available from ExxonMobil Chemical Company (Houston, Tex.); and ExxonMobil™ HDPE HD 7845.30 available from ExxonMobil Chemical Company (Houston, Tex.). In one particular embodiment, the thermoplastic film is uniaxially oriented. In another particular embodiment, the thermolastic film is biaxially oriented.

According to still other exemplary embodiments, the exterior layer includes paper or a paper-like material.

FIG. 2 shows another exemplary embodiment of an oxygen scavenging film 200 including a product contact layer 212 and a gas barrier layer 214 according to an exemplary embodiment. The film 200 is substantially similar to film 100 except that film 200 does not include an exterior layer. Film 200 may be itself used to form an oxygen scavenging package or may be coupled to one or more additional films to achieve desired film characteristics (e.g., laminated to a semi-rigid thermoformable packaging material) before being formed into a package.

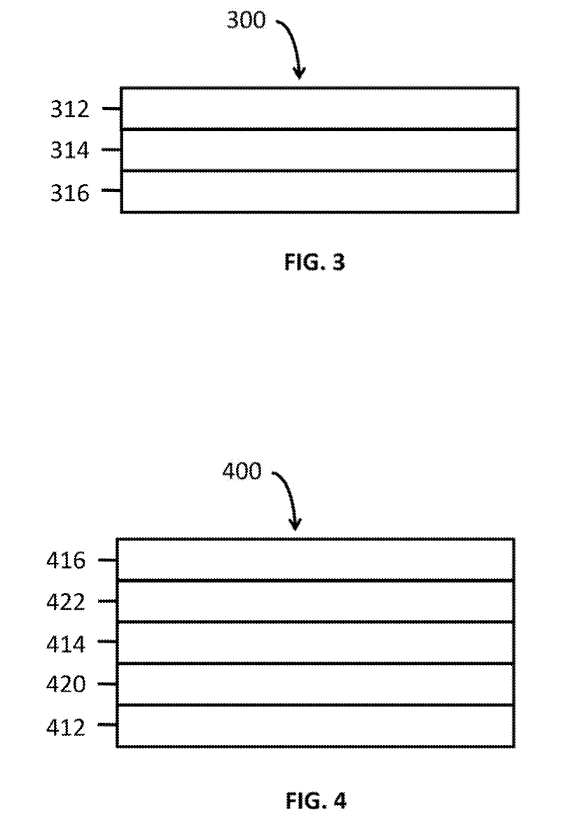

FIG. 3 shows another exemplary embodiment of an oxygen scavenging film 300 including a product contact layer 312, a gas harrier layer 314, and an exterior layer 316 according to an exemplary embodiment. According to this exemplary embodiment, the film 300 is palindromic (e.g., the structure is A/B/A, A/B/C/B/A, etc.), both the product contact layer and the exterior layer comprising COC and a catalyst. In some exemplary embodiments the catalyst is a palladium catalyst that is present in the range of 50-200 ppm. In other exemplary embodiments, a film may be substantially palindromic wherein the product contact layer includes COC and a catalyst, while the exterior layer comprises COC but no catalyst.

The gas barrier layer 314 comprises EVOH according to an exemplary embodiment. EVOH is otherwise known as saponified or hydrolyzed ethylene vinyl acetate copolymer, and refers to a vinyl alcohol copolymer having an ethylene comonomer. EVOH is generally prepared by the hydrolysis (or saponification) of an ethylene-vinyl acetate copolymer. The degree of hydrolysis is preferably from about 50 to 100 mole percent, more preferably, from about 85 to 100 mole percent, and most preferably at least 97%. It is well known that to be a highly effective oxygen barrier, the hydrolysis-saponification must be nearly complete, to the extent of at least 97%. EVOH is commercially available in resin form with various percentages of ethylene and there is a direct relationship between ethylene content and melting point. For example. EVOH having a melting point of about 175° C. or lower is characteristic of EVOH materials having an ethylene content of about 38 mole % or higher. EVOH having an ethylene content of 38 mole % has a melting point of about 175° C. With increasing ethylene content the melting point is lowered. Also, EVOH polymers having increasing mole percentages of ethylene have greater gas permeabilities. A melting point of about 158° C. corresponds to an ethylene content of 48 mole %. EVOH copolymers having lower or higher ethylene contents may also be employed. It is expected that processability and orientation would be facilitated at higher contents; however, gas permeabilities, particularly with respect to oxygen, may become undesirably high for certain packaging, applications which are sensitive to microbial growth in the presence of oxygen. Conversely, lower contents may have lower gas permeabilities, but processability and orientation may be more difficult.

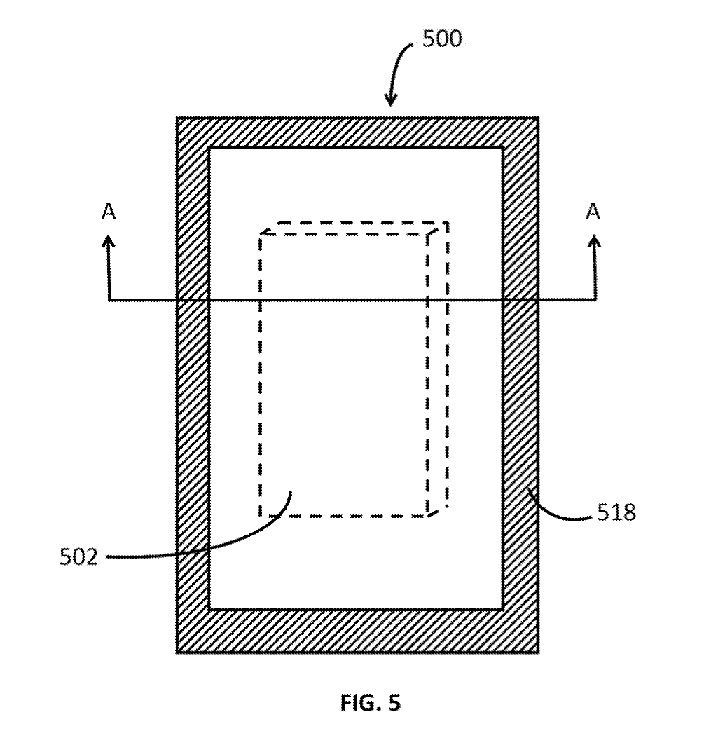

FIG. 4 highlights another exemplary oxygen scavenging film. Like oxygen scavenging film 300 of FIG. 3, the oxygen scavenging film 400 shown in FIG. 4 includes a product contact layer 412 comprising COC and a catalyst, a gas barrier layer 414 that comprises EVOH, and an exterior layer 416 that comprises COC. Oxygen scavenging film 400 further includes layers 420 and 422, layer 420 being interior to gas barrier layer 414 and layer 422 being exterior to gas barrier layer 414. According to one exemplary embodiment, layers 420 and 422 include HDPE. Layers 420 and 422 are configured to protect the EVOH gas barrier layer from moisture. According to other exemplary embodiments, layers 420, 422 may provide this and/or other benefits (e.g., structural, processing, etc.).

It will be appreciated by those reviewing this disclosure that the exemplary films disclosed herein may further include layers in addition to the product contact layer and gas barrier layer. This includes an exterior layer as well as other layers that may be disposed between the product contact layer and the gas barrier layer and or disposed between the gas barrier layer and an exterior layer.

### Package

The oxygen scavenging films of the present disclosure may be used to make pharmaceutical packaging in any number of formats. The films are particularly beneficial for transdermal patch applications, oral strip applications, e-cigarette cartridge applications, and other pharmaceutical applications involving oxygen-sensitive pharmaceutical active agents; for these applications the integrity of these pharmaceutical active agents may be detrimentally impacted by a number of externalities, one of them being oxygen.

Moreover, as discussed earlier in this disclosure, another significant consideration for pharmaceutical packaging for many pharmaceutical products involving pharmaceutical active agents is the ability of the film to resist migration of the pharmacological active agents (or excipients) between the product and the film; stated otherwise, it is desirable for packaging for these applications to be anti-scalping. The Applicant was recently surprised to find that COC provides particularly good anti-scalping performance, as, disclosed in PCT/US52015/015246 filed on Feb. 10, 2015 and titled “Anti-Scalping Pharmaceutical Packaging Film”. It is disclosed therein that that both the glass transition temperature of the layer comprising ethylene norbornene copolymer and the Hansen Solubility Parameter (HSP) of the active pharmacological agent to be stored in contact (direct or indirect) with the product contacting layer comprising ethylene norbornene copolymer can be factors in determining whether the product contacting layer can serve as an effective anti-scalping layer. Thus, it is understood that some embodiments of the films disclosed herein are particularly beneficial where the Hansen Solubility Parameter RED values of one or more of the excipients for the COC are 0.5 or greater. More desirably, the RED values are 0.6, 0.7, 0.8, 0.9, or 1 or greater.

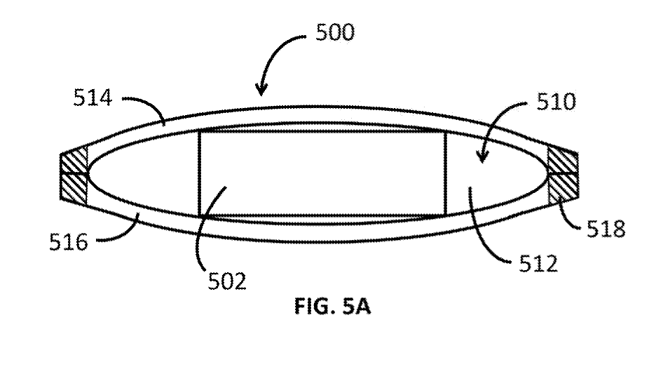

Referring to FIGS. 5 and 5A, an oxygen scavenging pharmaceutical package 500 that is a fiat format pouch for a transdermal patch, oral strip or similar application is shown made from a suitable oxygen scavenging, film of this disclosure, such as film 100, according to an exemplary embodiment. The package 500 includes a product storage space 510 that is shown containing an exemplary product 502 such as a transdermal patch or oral thin strip and otherwise defining a headspace 512.

Referring in particular to FIG. 5A, the package 500 includes a first side wall 514 generally opposite a second side wall 516 with the product storage space 510 being located generally therebetween according to an exemplary embodiment. The first side wall 514 is shown coupled to the second side wall 516 by a heat seal 518. According to exemplary embodiments, the package is made exclusively (e.g., both of the first side wall and the second side wall) of an oxygen scavenging film of the present disclosure (e.g., film 100, film 200, film 300, film 400)). In some of these exemplary embodiments one oxygen scavenging film structure is used to make the package (e.g., using a form fill seal process including sealing the product contact layer of the film to itself), while in other exemplary embodiments more than one oxygen scavenging film structure may be used in combination to make a package. According to still other exemplary embodiments, films other than those of this disclosure may be used in combination with the Oxygen scavenging, films of this disclosure (e.g., the first side wall is an oxygen scavenging film of this disclosure and the second side wall is not).

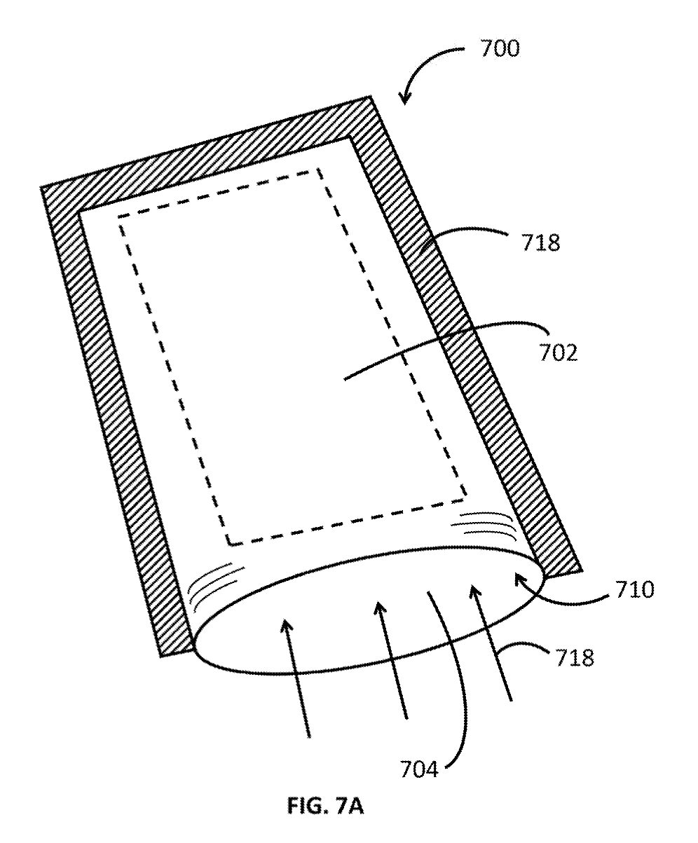

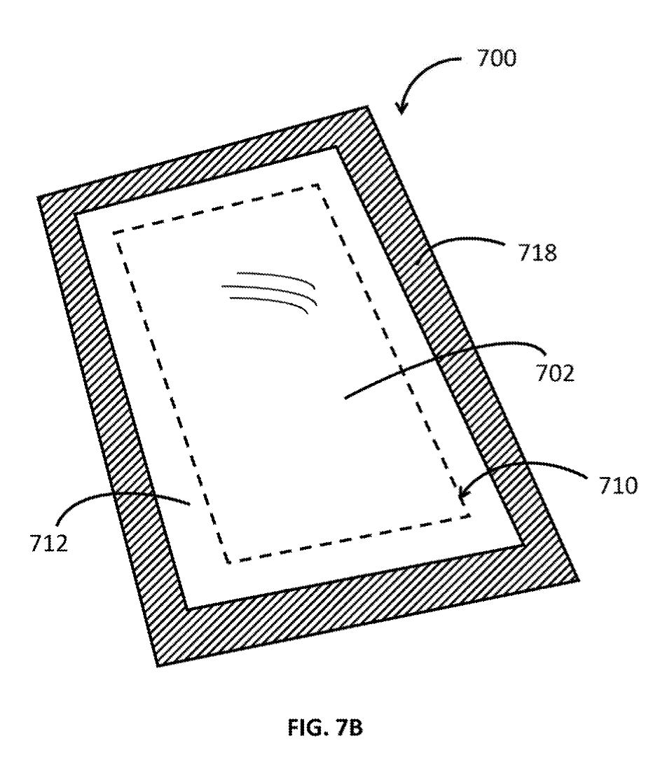

The head space 512 is shown as being sufficiently oxygen-free, and, in fact, oxygen-free (having less than 0.0% oxygen by volume). As will be discussed in more detail below, to achieve the oxygen-free headspace 512, a gas flush was introduced to the product storage space 510 through a gas flush opening (see, e.g., FIG. 7A) before package 500 was closed (here, by heat sealing). The gas flush comprised hydrogen. The hydrogen reacted with oxygen to reduce the level of oxygen within the head space, catalyzed by the palladium catalyst.

According to the exemplary embodiment, the first side wall 514 and the second side wall 516 of the package 500 both comprise a multilayer film that is film 100.

According to an another exemplary embodiment, one of the first side wall and the second side wall comprises a film according to the present disclosure (e.g., film 100) and the other of the first side wall and the second side wall is any film that includes a gas barrier layer.

For example, the other wall comprises a product contact layer including COC, a gas barrier layer that is foil, and an exterior layer that includes a polyester, such as polyester terephthalate (PET). As another example, the other wall includes an ethylene copolymer and a gas barrier layer.

According to other exemplary embodiments, the first side wall 514 and the second side wall 516 of the package 500 both comprise a multilayer film that is film 100.

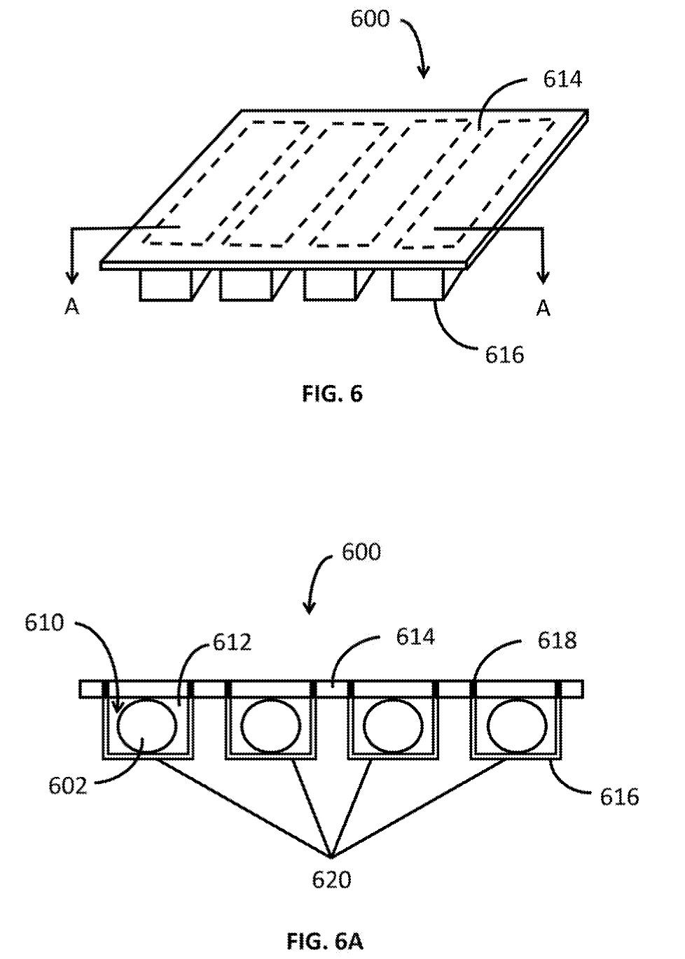

Referring to FIGS. 6 and 6A, an oven scavenging pharmaceutical package 600 for a pharmaceutical product that includes a pharmaceutical active agent is shown according to an exemplary embodiment. The package 600 is shown as a blister package including a product storage space 610 that is shown containing an exemplary pharmaceutical product 602 (e.g., an e-cigarette cartridges, a tablet, a capsule, a lozenge, etc.) and otherwise defining a headspace 612. It should be noted that, for ease of discussion, product storage space 610 will be used to refer collectively to the plurality of product storage spaces as shown in the blister package, headspace 612 will similarly be used to collectively refer to the headspaces as shown, and pharmaceutical product 602 will be used to collectively refer to the products as shown. That being said, it will be understood more generally that a package may include one or more product storage spaces, each product storage space being singular or collective of more than one subspace (e.g. similar to pockets 620). Relatedly, a given product storage space (or subspace) may include one or more products for some applications (e.g., each pocket 620 may include one or more than one pharmaceutical products).

Referring in particular to FIG. 6A, the package 600 comprising an oxygen scavenging film of the present disclosure includes a lid 614, shown as blister lidding or a top blister component, generally opposite a container 616, shown as a blister base or bottom, component, with the product storage space 610 being generally defined by pockets 620 according to an exemplary embodiment. The lid 614 is shown coupled to the container 616 by a heat seal 618.

The headspace 612 is shown sufficiently free of oxygen. As will be discussed in more detail below, to achieve the sufficiently oxygen-free headspace 612, a gas flush was introduced to the product storage space 610 before the lid 614 was sealed to the container 616 to close package 600. The gas flush comprises hydrogen. The hydrogen reacts with oxygen to reduce the level of oxygen within the head space, catalyzed by the palladium catalyst.

According to an exemplary embodiment, the lid 614 comprises the oxygen scavenging film 100.

According to another exemplary embodiment, lid 614 comprises an alternative of the oxygen scavenging film 100 wherein the exterior layer is paper rather than OPET. According to other exemplary embodiments, the lid 614 comprises any oxygen scavenging film according to the present disclosure suitable for use as a blister lidding component. According to still other exemplary embodiments, the lid 614 is not an oxygen scavenging film, but is any lidding film suitable for use with a blister base component that comprises a suitable oxygen scavenging film according to the present disclosure.

According to an exemplary embodiment, the container 616 comprises oxygen scavenging film 400.

According to another exemplary embodiment, the container 616 comprises oxygen scavenging film 300, where oxygen scavenging film 300 a forming web that is thermoformable or thermoforming. According to other exemplary embodiments, the container 616 comprises any oxygen scavenging film according to the present disclosure suitable for use as a blister base component. According to still other exemplary embodiments, the container is not an oxygen scavenging film, but is any blister base component suitable for use with a blister lidding component comprising a suitable oxygen scavenging film according to the present disclosure. According to still other exemplary embodiments, the container comprises a film that is a cold forming film.

According to one exemplary embodiment, the pharmaceutical product 602 includes e-cigarette cartridges. E-cigarette cartridges include nicotine, which is oxygen-sensitive and susceptible to scalping in many traditional pharmaceutical industry packaging formats. For such an application, it is desirable (though not necessary) to have both the lid and the container comprise oxygen scavenging films according to the present disclosure. For example, including film 100 and film 400, respectively. According to other exemplary embodiments, the product contact layers of both films comprise at least 90 wt. % of COC, at least one of the films being an oxygen scavenging film according to the present disclosure.

It is worth noting that, when the blister lidding component and blister container component are not both films according to the present disclosure, it may be desirable for the film(s) that are not films according to the present disclosure to have suitable anti-scalping characteristics for use with the given pharmaceutical active agent.

Even where the films are both films according to this disclosure, the wt. % COC in the product contact layer may be the same or may be different. According to some embodiments, the product contact layers of both films comprise at least 90 wt. % of COC. According to other exemplary embodiments, the product contact layer of one film comprises at least 90 wt. % of COC, while the product contact layer of the other film comprises less than 90 wt. % of COC.

According to still other exemplary embodiments, the product contact layers of both films comprise less than 90 wt. % of COC.

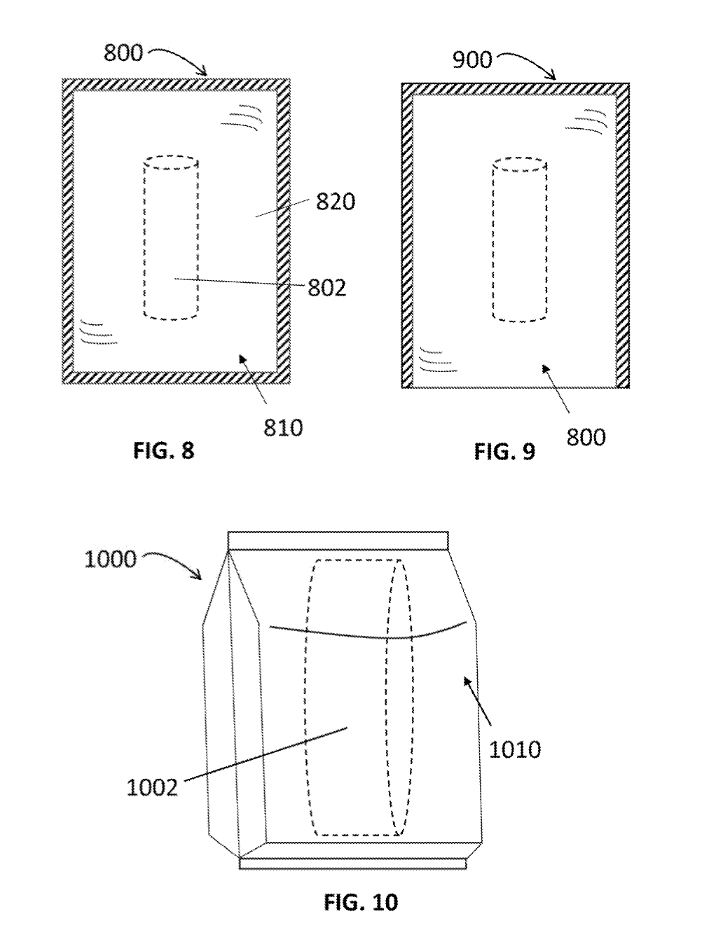

Referring to FIGS. 8, an oxygen scavenging package 800 that is a pouch or bag comprises an oxygen scavenging film of the present disclosure according to an exemplary embodiment. The package 800 includes a product storage space 810 that is shown containing an exemplary product 802, such as an e-cigarette cartridge, and otherwise defining a headspace 812. A body 820 of the package 800 may be made entirely or in part from one or more of the oxygen scavenging films of the present disclosure. For example, film 100 may be used to make the body 820.

FIG. 9 shows another exemplary embodiment of an oxygen scavenging package 900 that is a pouch or bag comprises an oxygen scavenging film of the present disclosure. Referring to FIG. 10, an oxygen scavenging package 1000 that is a bag, specifically an intermediate transport or bulk bag, is shown comprising an oxygen scavenging film of the present disclosure according to an exemplary embodiment. In a product storage space 1010 a pharmaceutical product 1002 is shown as a reel of transdermal patches or oral thin strips.

Pouch or bag formats such as packages 800, 900, and 1000 are particularly desirable for transporting pharmaceutical products that are in a pre-end-consumer state (e.g., because the products are being transferred in bulk or still require further processing). For example, transdermal patches connected in a reel format may be transported in a bag that is an intermediate form of packaging (e.g., prior to the end-consumer packaging format of a flat-format pouch) for further processing (e.g., separation) at a later time. Of course, the pouches and bags need not be an intermediate packaging format but may be the end-consumer packaging format (e.g., e-cigarettes cartridges).

According to an exemplary embodiment, the films of the present disclosure may be used for still other package formats, including, but not limited to, formats where the container is a tray with lidding and still other formats where the container (e.g., a tray) is in a bag or similar enclosure.

According to exemplary embodiments, the headspace of the packages disclosed herein may include 1% of less oxygen gas by volume. In some exemplary embodimmts, the headspace may include 0.5%, or less oxygen gas by volume. In some exemplary embodiments, the headspace may include 0.2% or less oxygen gas by volume. In some exemplary embodiments, the headspace may include 0.1% or less oxygen gas by volume. hi other exemplary embodiments, the headspace may be an oxygen-tree headspace (0.0% oxygen gas by volume). In still other exemplary embodiment, a sufficiently oxygen-free headspace can be achieved, where a headspace has reached an oxygen gas level by volume that is suitable or otherwise desirable for a given application. Generally, the oxygen gas measurement assumes a suitable or predetermined passage of time to allow for oxygen scavenging.

Packages 500, 600, 800, 900, 1000, and others contemplated by this disclosure may be made by any suitable methods known in the art, as would be appreciated by a person of skill in the art.

### EXAMPLE 1

Example 1 is an example film structure and method of manufacture for a film intended for use in packaging pharmaceutical products such as transdermal patches and oral strips. The structure of this exemplary film when finished is OPET/PEI/LDPE/EAA/Aluminum Foil/EAA/LDPE/(COC+palladium).

The base film was comprised of five layers having an ordered structure of:

/Layer 1/Layer 2/Layer 3/Layer 4/Layer 5/corresponding to:

/exterior layer 1/primer layer 2/bulk layer 3/adhesive layer 4/barrier layer 5/or more particularly,

/OPET/PEI/LDPE/EVA/Aluminum

Layer 1 was a commercially available 0.92 mil, biaxially oriented polyethylene terephthalate (OPET) film corona treated on one side. The treated OPET film received a second corona treatment on the previously treated side prior to receiving an anchor coating of a water-based polyethyleneimine (PEI) primer (Layer 2) that was contact coated onto the corona treated side of the OPET film and dried just prior to lamination of the OPET film to 0.35 mil a aluminum foil (Layer 5) using a coextrusion of LDPE (Layer 3) and EAA (Layer 4). Layers 3 and 4 were produced by the two-layer coextrusion of LDPE and EAA. The anchor coated side of the OPET film was laminated to 0.35 mil aluminum foil with a coextrusion of LDPE and FAA. The LDPE as a blend of 87.5 wt. % LDPE laminate resin and 12.5 wt. % of a white colorant in a carrier resin. The oxygen and moisture barrier was provided by a commercially available packaging grade aluminum foil.

A three-layer coextrusion of EAA, LDPE and a blend of ethylene-norbornene copolymer (COC) and palladium nanoparticles is extrusion coated onto the corona treated aluminum foil.

The film is well suited to package articles for collecting or administering, a pharmaceutical product including a pharmaceutical active agent, such as transdermal drug delivery patches or oral thin strips. The film has advantageous moisture barrier, oxygen barrier, anti-scalping properties, as well as oxygen scavenging when the package is flushed with a gas flush including hydrogen as discussed later in this disclosure.

### EXAMPLE 2

Example 2 is an example film structure and method of manufacture for a film intended for use as a lidding for a blister package. The structure of this exemplary film when finished is aluminum foil/EAA/LDPE/(COC+palladium)

A three-layer coextrusion of EAA, LDPE and a blend of ethylene-norbornene copolymer (COC) and palladium nanoparticles is extrusion coated onto the corona treated aluminum foil.

### EXAMPLE 3

Example 3 is an example film structure and method of manufacture for a film intended for use as a container that is a blister base component for a blister package. The film is a cold forming film. The structure of this exemplary film when finished is aluminum OPA/adhesive/aluminum/EAA/LDPE/(COC+palladium)

The film may be manufactured by adhesive laminating the OPA to aluminum foil. EAA, LDPE, and the COC+palladium are coextruded. The lamination and coextrusion are then extrusion laminated together (the EAA adjacent to the aluminum foil).

### Method of Achieving a Sufficiently Oxygen-Free Headspace and/or Oxygen-Free Headspace

Exemplary embodiments of a method for achieving a sufficiently oxygen-free headspace in a pharmaceutical package include utilizing an oxygen scavenging film according to the present disclosure. As discussed in more detail above, these oxygen scavenging films comprise a gas barrier layer and a product contact layer comprising COC and hydrogenation-accelerating palladium (or platinum) catalyst. A gas flush is introduced into a pharmaceutical storage space of the page. The gas flush includes hydrogen that combines with oxygen in the presence of a catalyst to remove the oxygen gas from the headspace.

Referring to FIGS. 7A and 7B, the pharmaceutical package is a flat format pouch 700 particularly well suited for transdermal patch and oral strip applications according to an exemplary embodiment. FIG. 7A shows the package 700 wherein the product storage space 710 is shown having an opening 704 providing access thereto. The pharmaceutical product 702 (e.g., a transdermal patch or oral strip) is shown already positioned in the product storage space 710. A gas flush 706 is introduced through opening 704, which functions as the gas flush opening. The upper limit of a range of the ratio of inert gas to hydrogen gas in the gas flush should reflect the flammability limit of the hydrogen gas in the flush (i.e., being lower than that limit). The lower end of the ratio range desirably reflects a quantity that is sufficient to react with the required amount of oxygen, as defined by the application. An exemplary gas flush includes nitrogen gas and hydrogen gas in a ratio in the range of 99.5:0.5-94.6:5.4. According to a particular embodiment, the gas flush includes nitrogen gas and hydrogen gas in an approximate ratio of 95:5. As would be appreciated by one of skill in the art, any suitable method of introducing the gas flush for such an application may be utilized. Generally, the flush may include inert gases other than nitrogen gas (e.g., carbon dioxide, etc.).

Referring in particular to FIG. 7B, a heat seal 718 is subsequently completed so that it completely encloses the product storage space 710 and formally defines a headspace 712 of the product storage space 710. Immediately after the gas flush, a reduced amount of oxygen gas remains (e.g., 0.5-2% of the headspace by volume is oxygen gas). The palladium catalyst catalyzes the reaction between the molecular hydrogen and the molecular oxygen. Because of the gas barrier layer the hydrogen substantially remains in the product storage space 710 and additional oxygen gas is substantially prevented from entering the product storage space 710. The molecular hydrogen and the molecular oxygen continue to react, catalyzed by the palladium catalyst, until the headspace 712 is sufficiently free of oxygen gas. No additional energy sources, generators or other inserts arc required. The pharmaceutical product 702 is substantially uncompromised by oxygen or moisture. No additional inputs or steps are required after the package 700 is sealed closed to remove the oxygen.

Utilizing the above-described gas flush process, a film sample of COC with 100 ppm Pd was compared to a high oxygen barrier lamination containing foil and Barex® resin by INEOS as the sealant. Table 3 shows the results in % volume of oxygen gas.

TABLE 3
oxygen gas percentages by volume

| | Day 0 | Day 4 | Day 6 | Day 12 |
|---|---|---|---|---|
| COC w/100 ppm Pd | 0.8% | 0.3% | 0.2% | 0.1% |
| Barex | 0.8% | 0.8% | 0.8% | 0.8% |

As indicated in Table 3, the sample of COC with 100 ppm palladium catalyst significantly reduced the oxygen in the headspace of the 6 inch by 6 inch foil based pouches, whereas the oxygen level in the foil based pouch with the Barex® sample enclosed therein remained constant.

It is worth noting that the oxygen percentage by volume may be reduced to a sufficient r even oxygen-free level more quickly than indicated by this test. For example, a package with a smaller headspace and larger surface area will scavenge faster. For example, Applicant was able to provide an oxygen-free environment within a test package in less than one day. As would be understood by a person of skill in the art, other factors may impact the rate of reduction of oxygen by percent volume (e.g., temperature, catalyst distribution within the polymer (e.g., including considering layer thickness), catalyst loading level, etc.).

### EXAMPLE 4

Applicant created a film including a product contact layer comprising COC (Topase® 8007F-600) and palladium catalyst (ColorMatrix Hycat 280-10119-1) at about 100 ppm. This film was formed using a collapsed bubble method of manufacture; accordingly, both the product contact layer and the exterior layer comprise COC (Topas® 8007F-600) and palladium catalyst (ColorMatrix Hycat 280-10119-1) at 100 ppm. A 3 inch by 3 inch sample of the film (i.e., total scavenger surface area of 18 in²) was placed in a 5 inch by 5 inch pouch (˜150 cc internal volume) made from a clear barrier film along with 1 mL of liquid nicotine in the product storage space of the pouch. The headspace of the pouch was flushed with a 95:5 nitrogen-to-hydrogen gas mixture and hermetically sealed. An initial headspace oxygen level was measured using a calibrated Mocon® Checkpoint II Portable Headspace Analyzer (i.e. Day 0 oxygen levels given in Table 4). Headspace oxygen levels could be tested by other common methods including internal package indicators such as the Mocon® Opted O2 model P. The pouch was stored at 39° C., 16% RH, and the oxygen gas level was measured at various time intervals, as seen in Table 4. The pouches were resealed after each headspace test. The tests were run in duplicate, using the same oxygen scavenging film. As can be seen from the results in Table 4 below, both films according to the present disclosure achieved an oxygen-free headspace.

TABLE 4
oxygen gas percentages by volume

| | Day 0 | Day 1 | Day 6 | Day 9 |
|---|---|---|---|---|
| Oxygen | 1.4 | 1.1 | 0.2 | 0.1 |
| scavenging film 1 | | | | |
| Oxygen | 0.9 | 0.7 | 0.0 | 0.0 |
| scavenging film 2 | | | | |

It is contemplated that films, may not include a gas barrier layer, the oxygen scavenging capabilities of the product contact layer the product contact layer being as described above) being sufficient for the application (i.e., type of product, level of oxygen sensitivity, storage needs, etc.).

It is further contemplated that the layer comprising COC and a palladium (or platinum) catalyst may be disposed exterior to a product contact layer. For example, a layer of COC may be disposed immediately adjacent to the product storage space and the layer comprising COC and palladium catalyst is exterior thereto. In still other exemplary embodiments, a relatively thin layer of a polymer (e.g., PE or other polyolefin, APET) may be disposed immediately adjacent to the product storage space and another layer comprising COC and palladium catalyst is exterior thereto. In addition, a product contact layer comprising COC and palladium may be discontinuously exposed (e.g. under a pattern applied cold seal layer). Alternatively, the discontinuous layer may comprise COC and palladium catalyst (e.g., pattern applied).

It is further contemplated that the films and other aspects of this disclosure may be utilized beneficially for applications other than pharmaceutical applications for which it is desirable to scavenge oxygen (e.g., food, beverages, etc.).

It is further still contemplated that the films, packages, and other aspects of this disclosure may be utilized in combination with desiccant technologies or other moisture absorbing technologies (e.g., for applications where the product has an especially high water sensitivity.)

As used herein, unless otherwise indicated, “product contact layer,” generally refers to the interior surface film layer of a package, whether or not the product contained in the package is in contact with that surface film layer. In a packaged product, the product contact layer can be in contact with the pharmaceutical active agent. As used herein, “in contact with the pharmaceutical active agent,” in the context of a layer of a film, means that under typical storage conditions some portion of the active agent will contact the layer. The active agent may be in direct contact with the product containing layer or may be in indirect contact with the layer. Indirect contact between the active agent and the product contacting layer on occur, for example, due to volatilization of the active agent or an active agent carrier within the package to cause the active agent, which is not stored in direct contact with the product contacting layer, to contact the layer. However, even if the active agent is not in contact with the sealing layer, it may be desirable for the product contact layer to be anti-scalping to provide assurance that if an active agent accidentally became exposed to the sealing layer, the sealing layer would not substantially scalp the active agent.

The term “adhesive layer,” or “tie layer,” refers to a layer or material placed on one or more layers to promote the adhesion of that layer to another surface. Preferably, adhesive layers are positioned between two layers of a multilayer film to maintain the two layers in position relative to each other and prevent undesirable delamination. In some exemplary embodiments a peelable tie layer may he used which is designed to have either cohesive failure or delamination from one or both adjacent layers upon application, of a suitable manual force to provide an opening feature for a package made from the film. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may comprise components of both the first layer and the second layer to promote simultaneous adhesion of the adhesive layer to both the first layer and the second layer to opposite sides of the adhesive layer.

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all of the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

For purposes of the present disclosure, recitations of numerical ranges by endpoints include all numbers subsumed within that range (e.g., 1 to 5 includes 1, 1.5, 2, 2,75, 3, 3.80, 4, 5, etc.,). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied.

Thus, methods, systems, devices, compounds and compositions for oxygen scavenging films and packages made therefrom are described. Various modifications and variations of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are apparent to those skilled in film manufacturing or related fields are intended to be within the scope of the following claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

### Recitation of Non-Limiting and Non-Exclusive Exemplary Embodiments

1. An oxygen scavenging film for packaging a product, the film comprising a product contact layer comprising COC and a palladium catalyst.

2. The film of claim 1, wherein the product is an oxygen-sensitive product.

3. The film of any of claims 1 or 1, wherein the product is a pharmaceutical product.

4. An oxygen scavenging film for packaging an oxygen-sensitive pharmaceutical product, the pharmaceutical product comprising a pharmaceutical active agent, the film comprising:
a gas barrier layer; and
a product contact layer comprising COC and a palladium catalyst.

5. The film of any of claims 1-4, wherein the palladium catalyst is disposed within the COC at a level of 25 ppm-400 ppm.

6. The film of any of claims 1-5, wherein the palladium catalyst is disposed within the COC at a level of 50 ppm-200 ppm.

7. The film of any of claims 1-6, wherein the palladium catalyst comprises a nanoparticle palladium catalyst.

8. The film of any of claims 1-7, further comprising an exterior layer, wherein the gas barrier layer is disposed between the exterior layer and the product contact layer.

9. The film of any of claims 1-8, wherein the gas barrier layer comprises a metallic foil layer.

10. The film of any of claims 1-8, wherein the gas barrier layer comprises an EVOH layer.

11. The film of any of claims 1-10, wherein the film is a flexible film.

12. The film of any of claims 1-9, wherein the film is a thermoforming film.

13. The film of any of claims 1-9, wherein the film is a cold forming film.

14. The film of any of claims 1-13, wherein the pharmaceutical active agent is an alkaloid.

15. The film of any of claims 1-14, wherein the pharmaceutical active agent is selected from the, group consisting of fentanyl, nicotine, lidocaine, estradiol, clonidine, ethinyl estradiol, oxybutynin, buprenorphine, granisitron, methylphenidate, and scopolamine.

16. The film of any of claims 1-15, wherein the pharmaceutical product is an e-cigarette cartridge.

17. A package for a pharmaceutical product comprising the film of any of claims 2-13.

18. A flat format package for a pharmaceutical product comprising the film of any of claims 2-9.

19. A blister package for a pharmaceutical product that comprising the film of any of claims 2-16.

20. A blister package component comprising the film of any of claims 2-16.

21. The blister package component of claim 20, wherein the blister package component is a blister lidding component.

22. The blister package component of claim 20, wherein the blister package component is blister base component.

23. A flat format pouch for an oxygen-sensitive thin format pharmaceutical product providing for oxygen scavenging without the presence of a hydrogen generator, the package comprising:
a thin format pharmaceutical product storage space; and
at least one gas-flush opening providing for ingress and egress of gas to the thin format pharmaceutical product storage space; and
a first multilayer film comprising:
   a product contact layer comprising COC and hydrogen-gas-activated palladium catalyst.

24. The flat format package of claim 23, wherein the first multilayer film further comprises a gas barrier layer exterior to the product contact layer.

25. The flat format package of any of claims 23-24, wherein the hydrogen-gas-activated palladium catalyst comprises a nanoparticle hydrogen-gas-activated palladium catalyst.

26. The flat format package of any of claims 23-25, wherein the hydrogen-gas-activated palladium catalyst is disposed in the COC.

27. The flat format package of any of claims 23-26, wherein the palladium catalyst is disposed within the COC of the first multilayer film at a level of 25 ppm-400ppm.

28. The flat format package of any of claims 21-27, wherein the palladium catalyst is disposed within the COC of the first multilayer film at a level of 50 ppm-200 ppm.

29. The flat format package of any of claims 21-28, further comprising, a first side wall generally opposite a second side all, the first side wall and second side wall substantially defining the thin format pharmaceutical product storage space.

30. The flat format package of any of claims 21-29, wherein the first wall comprises the first multilayer film and the second wall comprises a second multilayer film different from the first multilayer film.

31. The flat format package of any of claims 21-29, wherein the first wall and the second wall comprise the first multilayer film.

32. The flat format package of any of claims 2-32, wherein the gas barrier layer of the first multilayer film comprises a metallic foil.

33. The flat format package of any of claims 21-33, wherein the gas barrier layer of the first multilayer film comprises an aluminum foil.

34. The flat format package of any of claims 21-34, wherein the first multilayer film further comprises an exterior layer.

35. The flat format package of any of claims 21-35, wherein the exterior layer of the first multilayer film is PET.

36. The flat format package of any of claims 21-36, wherein the exterior layer of the first multilayer film is OPT.

37. The flat format package of any of claims 21-35, wherein the exterior layer of the first multilayer film comprises paper.

38. The flat format package of claim 30, wherein the second multilayer film comprises a gas barrier layer.

39. The fiat format package of claim 38, wherein the gas barrier layer of the second multilayer film comprises a metallic foil.

40. The flat format package of any of claims 38-39, wherein the as barrier layer of the second multilayer film comprises an aluminum foil.

41. A package for an oxygen-sensitive pharmaceutical product providing for oxygen scavenging without the presence of a hydrogen generator, the package comprising:
at least one pharmaceutical product storage space; and
a first multilayer film comprising:
   a product contact layer comprising COC and a hydrogen-gas-activated palladium catalyst; and
   a gas barrier layer exterior to the product contact layer; and a second multilayer film sealable to the first multilayer film.

42. The package of claim 41, wherein the first multilayer film is a lidding film.

43. The package of claim 42, wherein the gas harrier layer of the lidding film comprises a metallic foil layer.

44. The package of any of claims 41-43, wherein the second multilayer film includes a gas barrier layer.

45. The package of any of claims 41-44, wherein the gas barrier layer of the second multilayer film is EVOH.

46. The package of any of claims 41-44, wherein the gas barrier layer of the second multilayer film is a metallic foil layer.

47. The package of any of claims 41-46, wherein the second multilayer film includes a product contact layer, the product contact layer of the second multilayer film comprises COC.

48. The package daily of claims 41-47, wherein the package is a blister package.

49. The package of any of claims 41-46, wherein the package includes a tray.

50. The package of claim 41, wherein the second multilayer film is a lidding film.

51. The package of claim 50, wherein the second multilayer film comprises a gas barrier layer.

52. The package of any of claims 50-51, wherein the gas barrier layer of the second multilayer film comprises a metallic foil.

53. The package of any of claims 50-52, wherein the first multilayer film is a forming web.

54. The package of any one of claims 50-53, wherein the gas barrier layer of the first multilayer film is EVOH.

55. The package of any of claims 50-54, wherein the second multilayer film includes a product contact layer.

56. The package of any of claims 50-55, wherein the product contact layer comprises COC.

57. The package of any of claims 41-56, wherein the first multilayer film is sealed to the second multilayer film and there is 1% or less oxygen gas by volume in a headspace of the pharmaceutical product storage space.

58. The package of any of claims 41-56 wherein the first multilayer film is sealed to the second multilayer film and a headspace of the pharmaceutical product storage space is oxygen-free.

59. The package of any of claims 41-56, wherein the first multilayer film is sealed to the second multilayer film and there is 0.0% oxygen gas by volume in a headspace of the pharmaceutical product storage space.

60. The package of any of claims 41-56, wherein a headspace of the pharmaceutical product storage space includes hydrogen gas and nitrogen gas introduced during a gas flush.

61. The package of any of claims 41-60, wherein the palladium catalyst is a nanoparticles palladium catalyst.

62. The package of any of claims 41-61, wherein the palladium catalyst is dispersed within the COC of the first multilayer film at a level of 25 ppm-400 ppm.

63. The package of any of claims 41-62, wherein the palladium catalyst is dispersed within the COC of the first multilayer film at a level of 50 ppm-200 ppm.

64. A method for achieving a sufficiently oxygen-free product storage space in a package, the method including:
utilizing a Multilayer packaging film, comprising:
   a product contact layer comprising COC and a hydrogen-gas-activated pal lady urn catalyst; and
   a gas barrier layer disposed exterior the product contact layer;
   wherein the multilayer packaging film at least in part defines the product storage space; and
introducing a gas flush into the product storage space, the gas flush including hydrogen gas.

65. The method of claim 64, wherein the package is a pharmaceutical package.

66. The method of any of claims 64-65, further comprising closing an opening to the product storage space.

67. The method of any of claims 64-66, further comprising providing for the hydrogen-gas-activated palladium catalyst to catalyze an oxidation reaction between molecular hydrogen and molecular oxygen.

68. The method of any of claims 64-67, wherein the gas flush further includes an inert gas.

69. The method of any of claims 64-68, wherein the ratio of the inert gas to hydrogen gas is between about 99.5:0.5 and 94.6:5.4.

70. The method of any of claims 64-69, wherein the ratio is about 95:5.

71. The method of any of claims 64-70, wherein the inert gas is nitrogen.

72. The method of any of claims 64-71, further comprising disposing an oxygen-sensitive product into the product storage space.

73. The method of any of claims 72, wherein the oxygen-sensitive product includes a pharmaceutical active agent.

74. The method of any of claims 72-73, herein the pharmaceutical active agent is selected from the group consisting of fentanyl, nicotine, lidocaine, clonidine, ethinyl estradiol, oxybutynin, buprenorphine, granisitron, methylphenidate, and scopolamine.

75. The method of any of claims 72-74, wherein the oxygen-sensitive product comprises an alkaloid.

76. The method of any of claims 64-75, wherein the gas barrier layer includes metallic foil.

77. The method of any of claims 64-76, further comprising reducing the oxygen gas content in a headspace of the product storage space to or less by volume oxygen gas.

78. The method of any of claims 64-77, further comprising reducing the oxygen gas content in a headspace of the product storage space to 0.2% or less by volume oxygen gas.

79. The method of any of claims 64-78, further comprising reducing the oxygen gas content in a headspace of the product storage space to 0.1% or less by volume oxygen gas.

80. The method of any of claims 64-79, further comprising reducing the oxygen gas content in a headspace of the product storage space until it is oxygen-free.

81. The method of any of claims 64-80, wherein the palladium catalyst is a nanoparticle palladium catalyst.

82. The method of any of claims 64-81, wherein the palladium catalyst is dispersed within the COC of the first multilayer film at a level of 25 ppm-400 ppm.

83. The method of any of claims 64-82, wherein the palladium catalyst is dispersed within the COC of the first multilayer film at a level of 50 ppm-200 ppm.

84. The method of any of claims 64-83, wherein the pharmaceutical package is a blister package.

85. The method of any of claims 64-84, wherein the pharmaceutical package includes a cold formed container.

86. The method of any of claims 64-84, wherein the pharmaceutical package includes a tray.

87. The method of any of claims 64-83, wherein the pharmaceutical package is a flat format pouch.

88. A method of making an oxygen scavenging film for packaging an oxygen-sensitive product, the method comprising:
providing COC;
providing, a plurality of palladium catalyst;
compounding the COC and the palladium catalyst; and
creating a product contact layer comprising the COC and palladium catalyst.

89. The method of claim 88, wherein the product is a pharmaceutical product.

90. The method of any of claims 88-89, wherein the product includes a pharmaceutical active agent.

91. The method of any of claims 88-90, further comprising coupling the product contact layer to a gas barrier layer.

92. A method of making an oxygen scavenging package, comprising:
utilizing a multilayer packaging film, the multilayer packaging film comprising,:
   a product contact layer comprising COC and a hydrogen-gas-activated palladium catalyst; and
   a gas barrier layer; and
forming a package including the multilayer film

93. The method of claim 92, wherein the product is, a pharmaceutical product comprising a pharmaceutical active agent.

94. The method of any of claims 92-93, wherein the package is a flat format package.

95. The method of any of claims 92-93, wherein the package is a blister package.

96. The method of any of claim 92, 93 or 95, wherein the package includes a cold formed container.

97. The method of an of claim 92, 93 or 95, wherein the package includes a tray.

What is claimed is:

1. A package for an oxygen-sensitive pharmaceutical product providing for oxygen scavenging without the presence of a hydrogen generator, the package comprising:
at least one pharmaceutical product storage space; and
a first multilayer film comprising:
a product contact layer comprising COC and a hydrogenation-accelerating catalyst; and
a gas barrier layer exterior to the product contact layer.

2. The package of claim 1, wherein the hydrogenation-accelerating catalyst is selected from the group consisting of a palladium catalyst and a platinum catalyst.

3. The package of claim 1, wherein the gas barrier layer comprises a metallic foil layer.

4. The package of claim 1, wherein the gas barrier layer comprises EVOH.

5. The package of claim 1, further comprising a second multilayer film including a product contact layer, the product contact layer of the second multilayer film being coupled to the product contact layer of the first multilayer film.

6. The package of claim 5, wherein the product contact layer of the second multilayer film comprises COC.

7. The package of claim 1, wherein the package is an e-cigarette cartridge package.

8. The package of claim 1, wherein the package includes a tray.

9. The package of claim 1, wherein the product contact layer of the first multilayer film is sealed to itself.

10. The package of claim 1, wherein there is 1% or less oxygen gas by volume in a headspace of the pharmaceutical product storage space.

11. The package of claim 1, wherein the pharmaceutical active agent is selected from the group consisting of fentanyl, nicotine, lidocaine, estradiol, clonidine, ethinyl estradiol, oxybutynin, buprenorphine, granisitron, methylphenidate, and scopolamine.

12. An oxygen scavenging film for packaging an oxygen-sensitive product, the product comprising a pharmaceutical active agent, the film comprising:
a gas barrier layer; and
a product contact layer comprising COC and a palladium catalyst.

13. The film of claim 12, wherein the palladium catalyst is a nanoparticle palladium catalyst disposed within the COC at a level of 25 ppm-400 ppm.

14. The film of claim 12, wherein the oxygen scavenging film is a flexible film.

15. The film of claim 12, wherein the oxygen scavenging film is a cold forming film.

16. The film of claim 12, wherein the oxygen scavenging film is a thermoforming film.

17. The film of claim 12, wherein the pharmaceutical active agent is an alkaloid.

18. A flat format package for a pharmaceutical product comprising the oxygen scavenging film of claim 12.

19. A blister package component comprising the film of claim 17.

20. (canceled)

21. A method for achieving a sufficiently oxygen-free product storage space in a package, the method including:
utilizing a multilayer packaging film, comprising:
a product contact layer comprising COC and a catalyst; and
a gas barrier layer disposed exterior the product contact layer;
wherein the multilayer packaging film at least in part defines a product storage space; and
introducing a gas flush into the product storage space, the gas flush including hydrogen gas and an inert gas.

22-27. (canceled)
